(19) United States
(12) Patent Application Publication
(10) Pub. No.: US 2025/0105328 A1
(43) Pub. Date: Mar. 27, 2025

(54) Fuel Cell Stack, Fuel Cell and Associated Vehicle

(71) Applicant: SYMBIO FRANCE, Venissieux (FR)

(72) Inventors: Julien Rapior, Vienne (FR); Sébastien Florian Ghio, Villeurbanne (FR); Guillaume Clément Santini, Sainte Foy Les Lyon (FR); Jean Hugo Desmars, Lyon (FR)

(21) Appl. No.: 18/832,359

(22) PCT Filed: Jan. 23, 2023
(86) PCT No.: PCT/EP2023/051583

§ 371 Date: Jul. 23, 2024

(30) Foreign Application Priority Data
Jan. 24, 2022 (FR) 2200558
Jan. 24, 2022 (FR) 2200562
Jan. 24, 2022 (FR) 2200565

(51) Int. Cl. H01M 8/248; H01M 8/0247; H01M 8/0258; H01M 8/0276; H01M 8/04537

(52) U.S. Cl. CPC H01M 8/248; H01M 8/0247; H01M 8/0258; H01M 8/0276; H01M 8/04537; H01M 2250/20

(57) ABSTRACT

The invention relates to a fuel cell stack comprising a plurality of identical bipolar plates (12), stacked in a stacking direction. Each bipolar plate is formed by two monopolar plates, which are placed one on top of the other and which together form at least one pocket at one end of the bipolar plate. Each pocket having an end opening configured to receive a pin of a fuel cell measurement module, any two successive bipolar plates being stacked head-to-tail.

The present invention relates to a fuel cell stack, a fuel cell comprising such a stack, and a vehicle comprising such a fuel cell.

Fuel cells are used as an energy source in various applications, in particular in electric vehicles. In polymer membrane electrolyte fuel cells (PEMFC), hydrogen is supplied to the anode of the fuel cell and oxygen is supplied as an oxidant to the cathode. Polymer membrane fuel cells (PEMFC) comprise a membrane-electrode assembly (MEA) comprising an electrically non-conductive, proton exchange, solid polymer electrolyte membrane having the anode catalyst on one side and the cathode catalyst on the opposite side. A membrane-electrode assembly (MEA) is sandwiched between a pair of electrically conductive elements, called bipolar plates, generally with interposition of gas diffusion layers, made e.g. of carbon fabric. Bipolar plates are generally rigid and thermally conductive. Same serve mainly as separators for the chemical species forming the gaseous reactants of the fuel cell and for a possible cooling fluid, and same serve as collectors of current for the anode and the cathode. The bipolar plates have channels with suitable openings for distributing gaseous reactants from the fuel cell over the surfaces of the respective anode and cathode catalysts and for discharging reaction products or residues, in particular water produced at the cathode.

A membrane-electrode assembly sandwiched between two bipolar plates forms a unit cell of the fuel cell, a plurality of unit cells being stacked to form a stack of the fuel cell. During the operation of the fuel cell, it is advantageous to supervise the unit cells, in particular by measuring the electrical characteristics of the cells.

For example, U.S. Pat. No. 9,997,792-A1 discloses a fuel cell comprising a stack of cells, connected to a computer by means of a ribbon of cables connected to each of the cells by connection tongues, the cables being held by a harness to press the cables against the connection tongues. However, the measurements made with such type of arrangement are unreliable and the cell takes a large space, moreover the cables tend to be damaged due to mechanical stresses such as vibrations or expansion generated during the operation of the cell, and hence reduce the service life.

DE102021202538A1 describes a fuel cell comprising a cell stack. Each of the bipolar plates comprise electrical contacts, each of which is configured to receive a mating connector. The electrical contacts are aligned along an axis of stacking of the cells, whereas insulating elements are positioned at the periphery of the membrane-electrode assemblies, between each bipolar plate, to prevent short circuits between two neighboring bipolar plates, in particular during the connection of the electrical contacts to the mating connectors. However, the insulating elements, and by extension the stack of bipolar plates, are relatively bulky.

It is such problems that the invention more particularly seeks to remedy, by proposing an improved fuel cell stack which would be both compact and more reliable.

To this end, the invention relates to a fuel cell stack. According to the invention, the stack comprises a plurality of bipolar plates, which are identical to each other, which each extend along a median plane and which are stacked along a direction of stacking orthogonal to the median plane, two consecutive bipolar plates forming therebetween a cell of the stack. Each bipolar plate is formed by two monopolar plates, which are superimposed and which together form at least one pocket at one end of the bipolar plate, each pocket having an end opening configured to receive a pin of a measurement module of the fuel cell, whereas any two successive bipolar plates are stacked head-to-tail.

By means of the invention, the head-to-tail mounting of the bipolar plates makes it possible to provide pockets the openings of which each has a width, measured along the direction of the stack, hence greater than an interval between two successive bipolar plates. The insertion of the pins in each pocket is thereby facilitated and furthermore the pins are thicker and hence stronger, which contributes to the reliability of the stack.

According to advantageous but non-mandatory aspects of the invention, such a stack can incorporate one or a plurality of the following features, taken individually or according to any technically permissible combination:
Each pocket opens out through the end opening in a direction of connection which is parallel to a longitudinal direction of the stack, the longitudinal direction being orthogonal to the direction of the stack,
whereas for any two consecutive bipolar plates, the direction of connection of each pocket of one of the two bipolar plates is oriented opposite to the direction of connection of each pocket of the other bipolar plate.
Each bipolar plate comprises a connection zone, where the at least one pocket of the bipolar plate is provided, and a mating zone, which is located opposite the connection zone with respect to a center of the bipolar plate,
whereas for any two consecutive bipolar plates, the connection zone of one of the two bipolar plates is arranged facing the mating zone of the other bipolar plate in the direction of stacking,
and the stack further comprises wedging means, which are interposed between each connection zone and the mating facing zone, so as to limit the deformations of each pocket of the connection zone when the pin associated with the pocket is inserted into said pocket.
The mating zones comprise bulges which are provided protruding from the polar plates and which extend toward the opposite connection zones, so as to limit the deformations of each pocket of the connection zone when the pin associated with the pocket is inserted into the pocket, forming the wedging means.
The wedging means comprise spacers, which are interposed between each connection zone and the opposite mating zone,
while each spacer is fastened to the mating zone.
Each bipolar plate comprises an anode outer face and a cathode outer face,
whereas for a given bipolar plate, the mating zone of the bipolar plate includes a spacer fastened to the anode face of the bipolar plate and a spacer fastened to the cathode face of the bipolar plate.
Each bipolar plate comprises an anode outer face and a cathode outer face,
whereas for a given bipolar plate, the wedging means comprise three spacers, two of the spacers being arranged on each side of the mating zone of the bipolar plate, on the anode face of the bipolar plate and on the cathode face of the bipolar plate, whereas the third spacer is arranged between the two monopolar plates forming the bipolar plate.
The wedging means comprise spacers, which are interposed between each connection zone and the opposite mating zone,
whereas for each bipolar plate, the wedging means associated with the plate comprise bridges of material, which connect the spacers together, and that the wedging means are mounted on an edge of the bipolar plate concerned, so that the spacers (32) are situated on each side of the mating zone.
The wedging means comprise spacers, which are interposed between each connection zone and the opposite mating zone,
whereas the stack also comprises membrane-electrode assemblies, which are each received between two consecutive bipolar plates and which extend between the connection zones and the opposite mating zones associated with the two bipolar plates,
and that some of the spacers are fastened to the membrane-electrode assemblies.
The spacers are made of an elastomer material.
Each bipolar plate comprises a connection zone, where the at least one pocket of the bipolar plate is provided, and a mating zone, which is located opposite the connection zone with respect to a center of the bipolar plate,
whereas for any two consecutive bipolar plates, the connection zone of one of the two bipolar plates is arranged opposite the mating zone of the other bipolar plate along the direction of stacking,
and that the connection zones are distributed in two rows, the two rows extending along the direction of stacking,
and that for each row the end openings of the pockets of that row are geometrically supported by an opening plane which is parallel to the axis of stacking, the mating zones associated with the connection zones of said row being formed set back from the opening plane, at a distance from the opening plane comprised between 1 mm and 5 mm, preferably greater than or equal to 2 mm.
   Advantageously, for at least one cell of the stack, the cell comprises:
a first polar plate, which includes:
   a peripheral zone, and
   a flow field of a reactive fluid, surrounded by the peripheral area,
a membrane-electrode assembly, which is superimposed on the first polar plate according to the direction of stacking, and which comprises:
   a peripheral portion, opposite the peripheral zone along the direction of stacking,
   a central portion comprising a proton exchange polymer membrane, surrounded by the peripheral portion, and.
   at least one gas diffusion layer, which is interposed, along the direction of stacking between the polymer proton exchange membrane and the flow field of the first polar plate, and
a first peripheral seal, comprising:
   a main part interposed, along the direction of stacking, between the peripheral zone and the peripheral portion of the membrane-electrode assembly, the main part surrounding the flow field and the gas diffusion layer associated with the flow field, the main part providing a seal against a reactive fluid between, on the one hand, a compartment of the cell delimited inside the cell, between the peripheral portion of the membrane-electrode assembly and the peripheral zone and, on the other hand, a zone external to the cell beyond the main part facing the compartment, and.
   fins, which extend from the main portion into the compartment,
      wherein:
the main part comprises two longitudinal portions, each of which extends parallel to a longitudinal direction orthogonal to the direction of stacking, which run along the flow field and which are arranged on each side of the flow field, the compartment including two bypass zones, each of which is delimited between, on the one hand, a respective longitudinal portion and, on the other hand, the flow field and the gas diffusion layer associated with the flow field,
for each longitudinal portion, at least one fin extends from that longitudinal portion into the corresponding bypass zone,
each fin includes:
   a junction part, via which the fin is attached to the corresponding longitudinal portion,
   an end part, interposed along the direction of stacking between the gas diffusion layer and the peripheral zone, and
   an intermediate part, linking the junction part to the end part, the intermediate part being inclined, in a projection onto the median plane, with respect to a transverse direction which is orthogonal to the direction of stacking and to the longitudinal direction,
for each longitudinal portion, the fin or fins attached to the longitudinal portion are inclined along the same direction with respect to the transverse direction,
when the stack is in the operational configuration, the fins attached to the longitudinal portion located on the bottom are inclined in the same direction as a flow of a reactive fluid associated with the first polar plate.
   Advantageously, for each peripheral seal, the fins attached to opposite longitudinal portions are inclined in opposite directions with respect to the transverse direction.

The invention further relates to a fuel cell, comprising:
a stack as described hereinabove,
two end plates on both sides of the stack, and
a plurality of modules for measuring the electrical characteristics of the cells, each module comprising pins, each of which is connected to a respective pocket.

Finally, the invention relates to a vehicle, which comprises at least one fuel cell as described hereinabove.

The invention will be better understood upon reading the following description, given only as an example and making reference to the drawings, wherein:

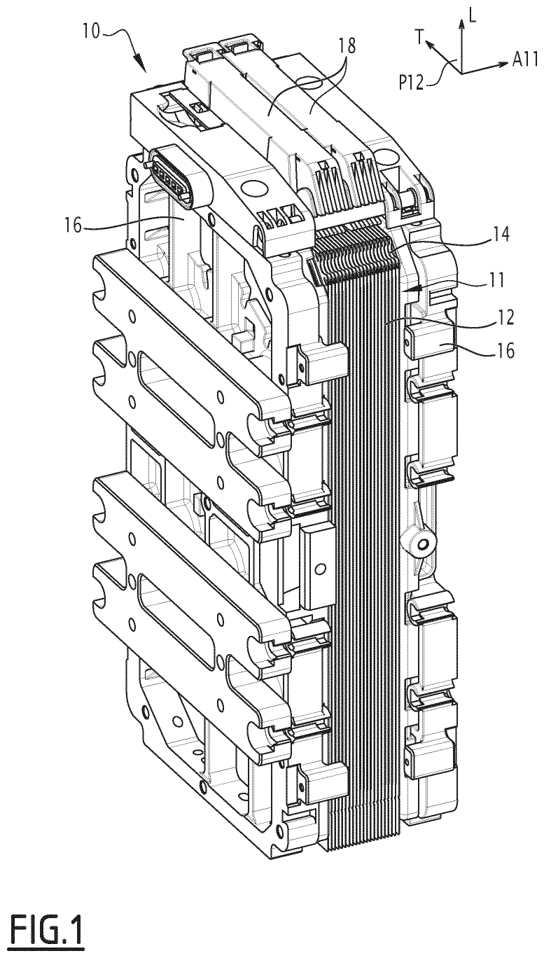

FIG. 1 is a schematic perspective front and side view of a fuel cell according to a first embodiment of the invention;

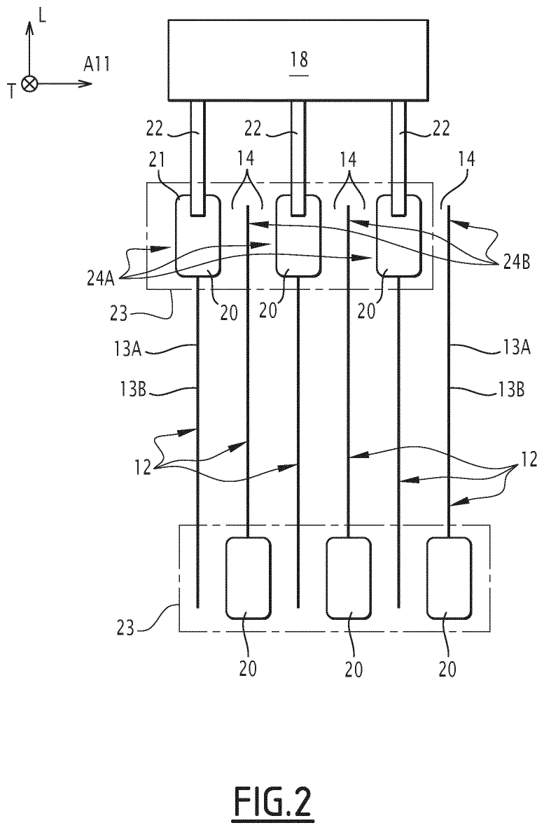

FIG. 2 is a schematic view of a stack of bipolar plates of the fuel cell shown in FIG. 1;

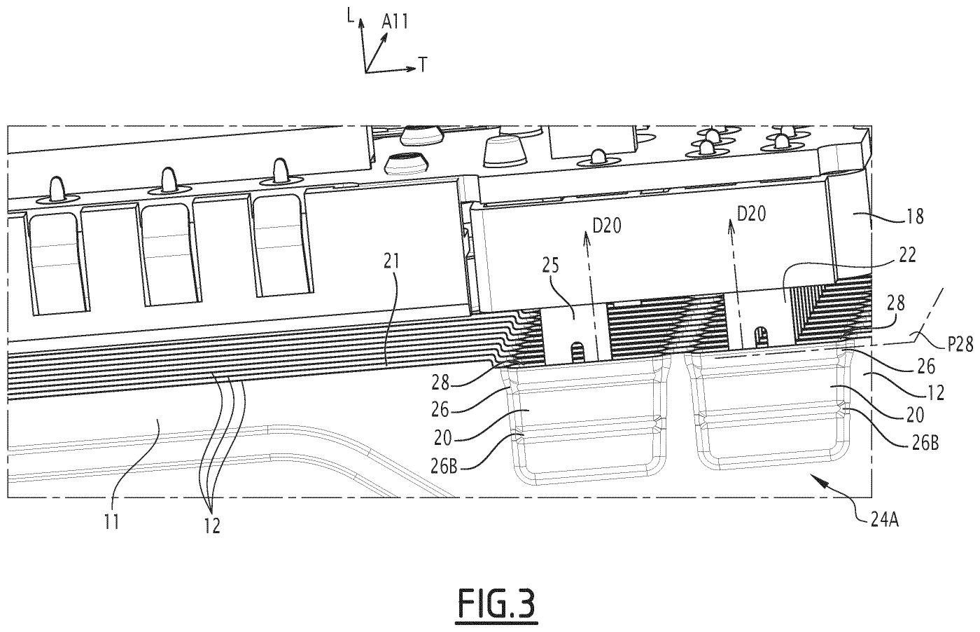

FIG. 3 is a schematic perspective view of the connection between the modules and the cells of the bipolar plate stack of the fuel cell shown in FIG. 1;

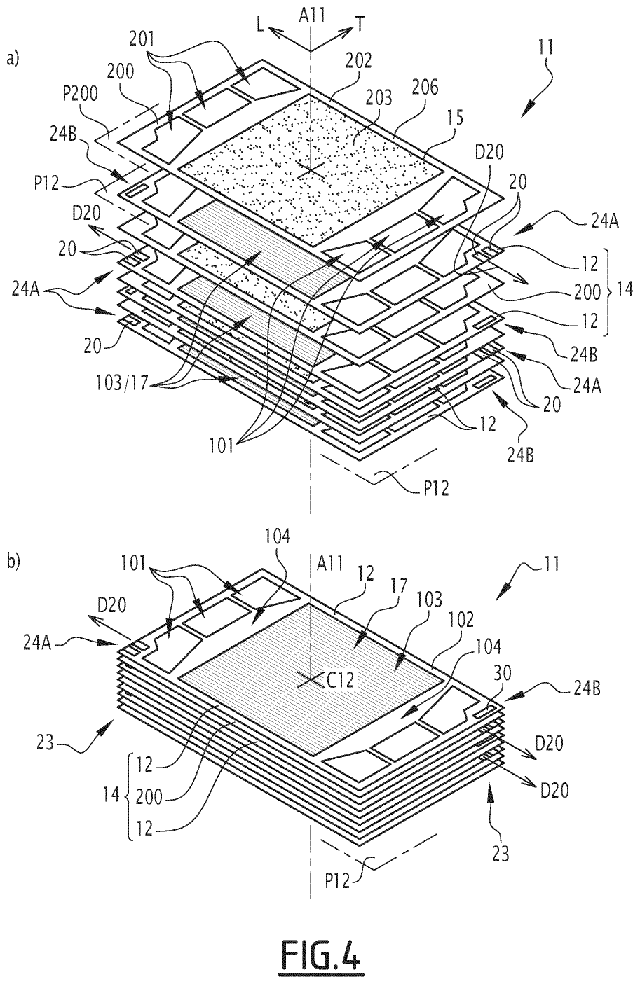

FIG. 4 schematically represents, on two inserts a) and b), the stack of FIG. 1, represented in a partially exploded perspective and in perspective;

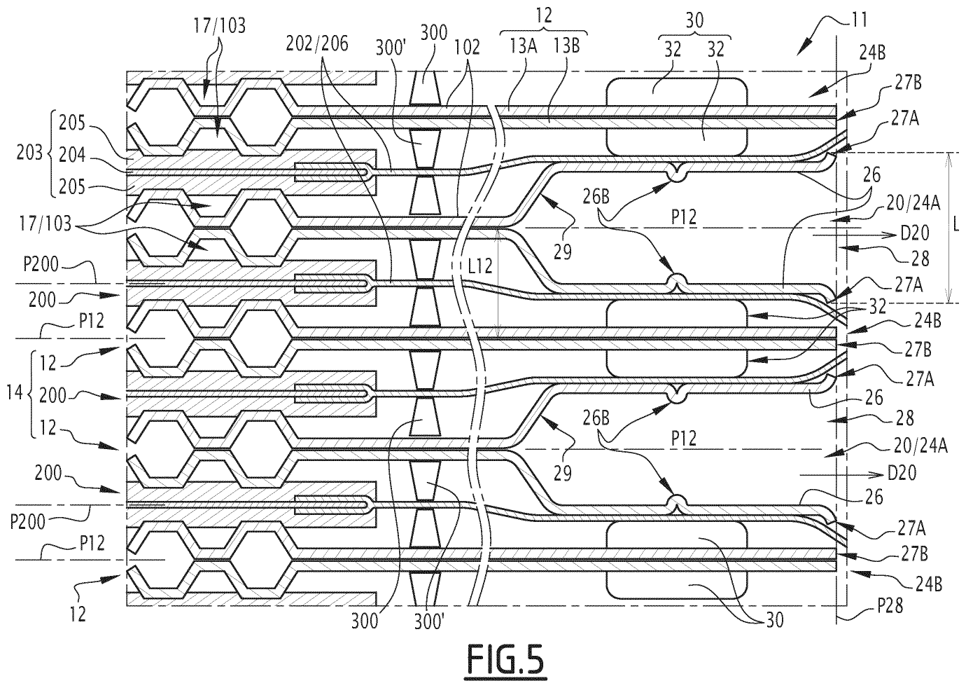

FIG. 5 schematically represents a section of the stack shown in FIG. 1;

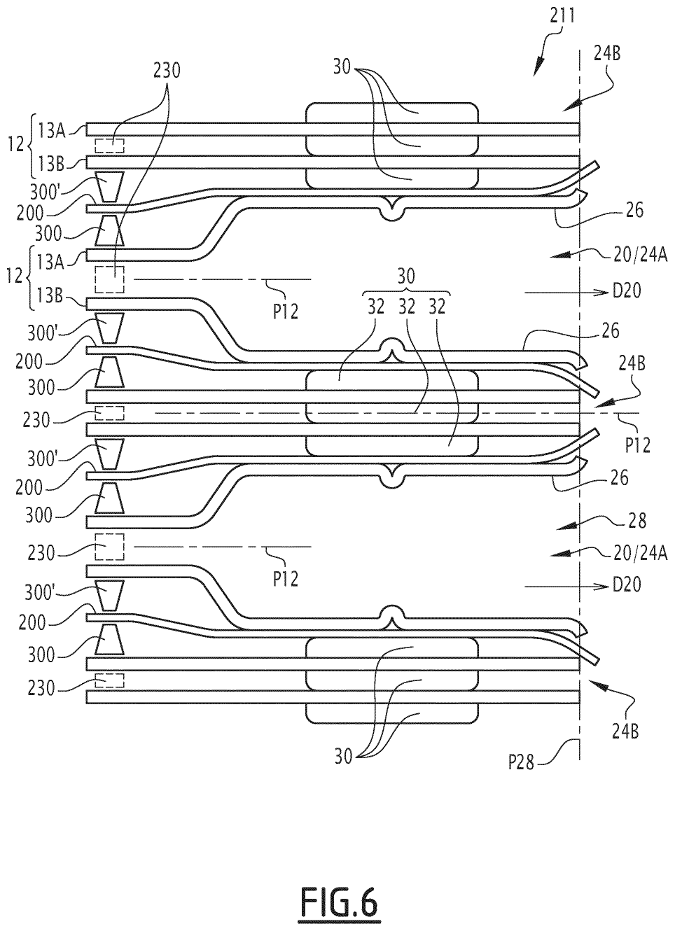

FIG. 6 is a schematic section of a fuel cell stack according to another embodiment;

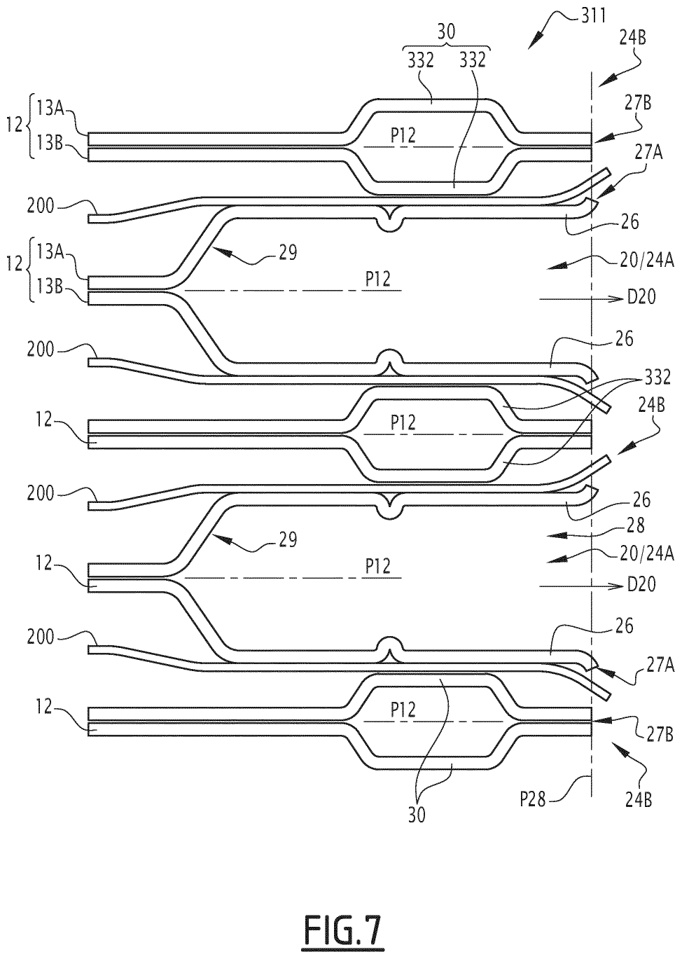

FIG. 7 is a schematic section of a fuel cell stack according to another embodiment;

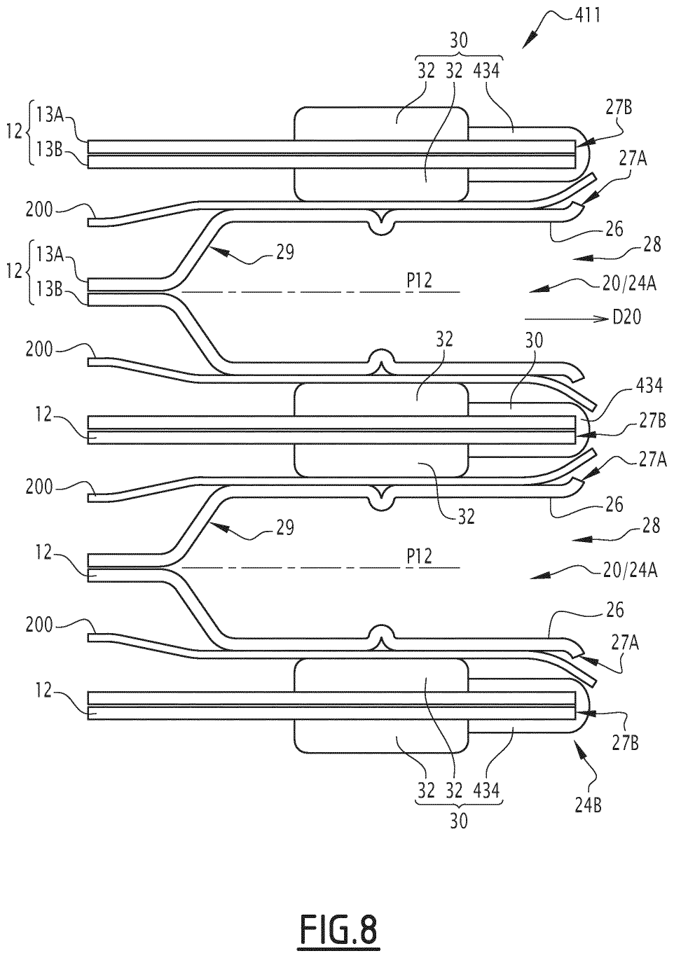

FIG. 8 is a schematic section of a fuel cell stack according to another embodiment;

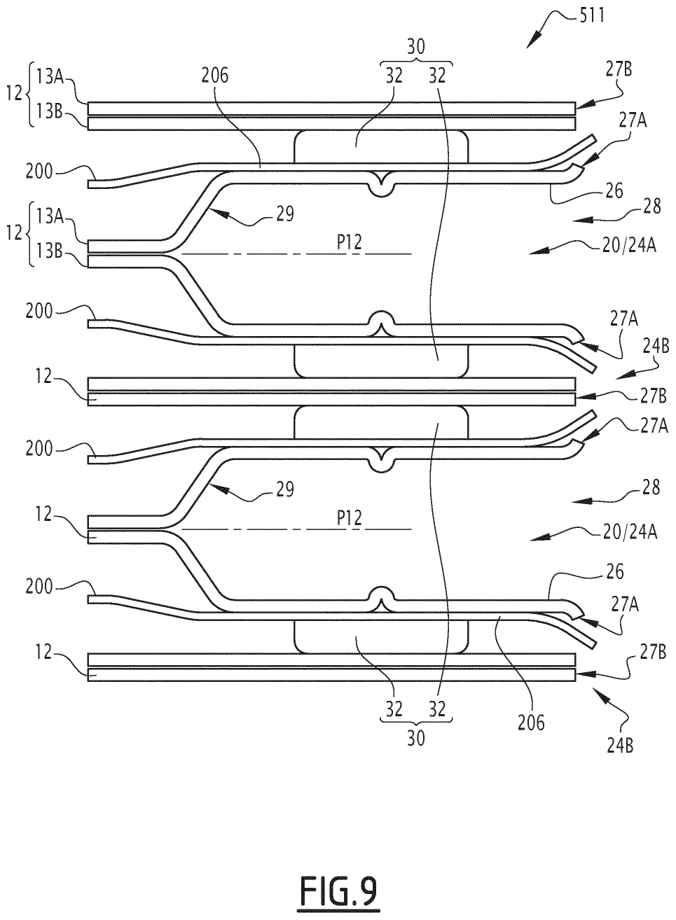

FIG. 9 is a schematic section of a fuel cell stack according to another embodiment;

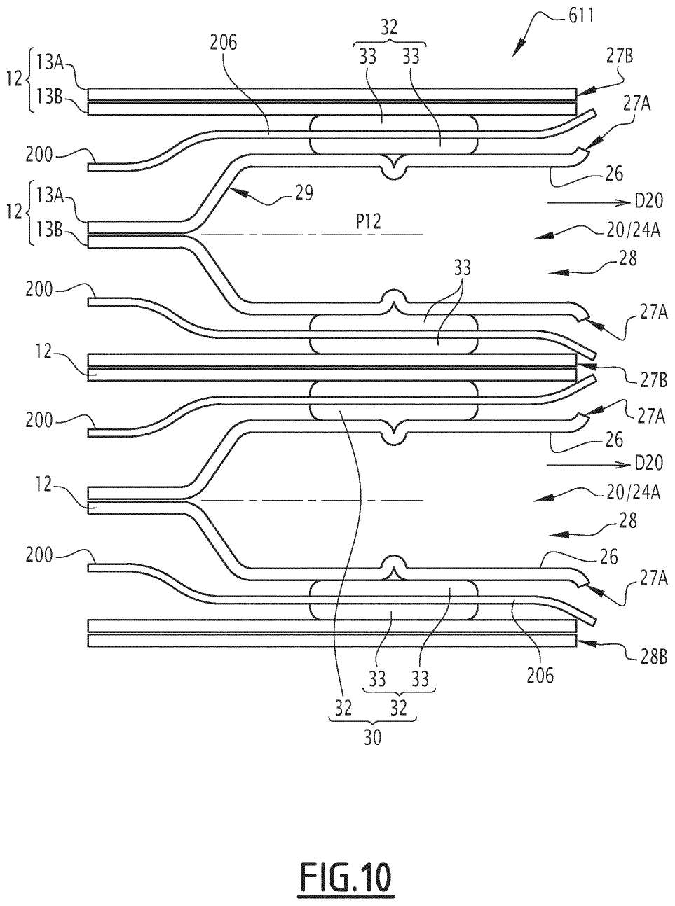

FIG. 10 is a schematic section of a fuel cell stack according to another embodiment;

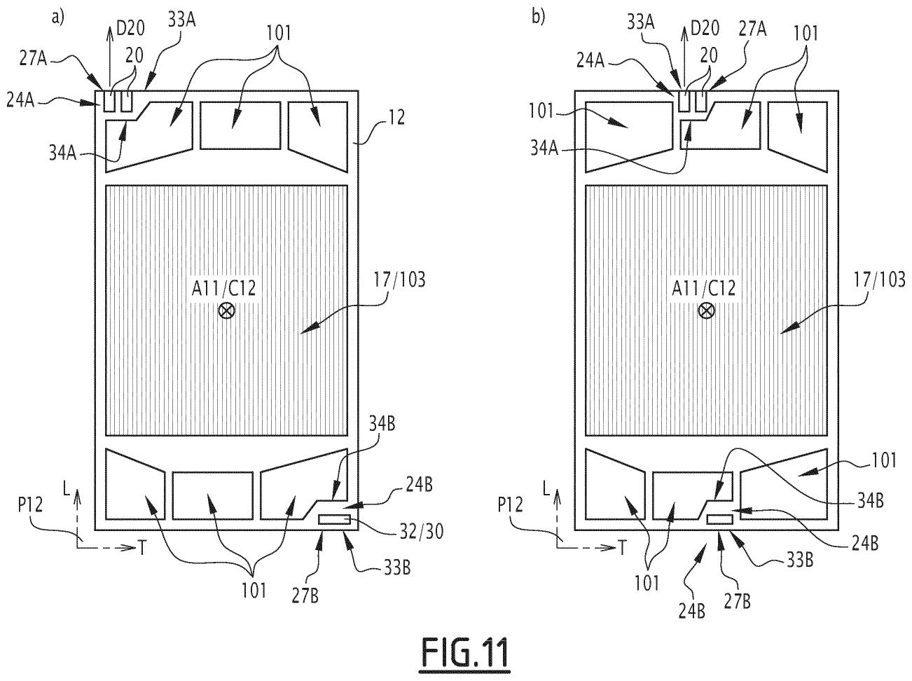

FIG. 11 shows, on two inserts a) and b), a bipolar plate belonging to the stack shown in FIG. 4 and to a fuel cell, respectively, according to another embodiment of the invention;

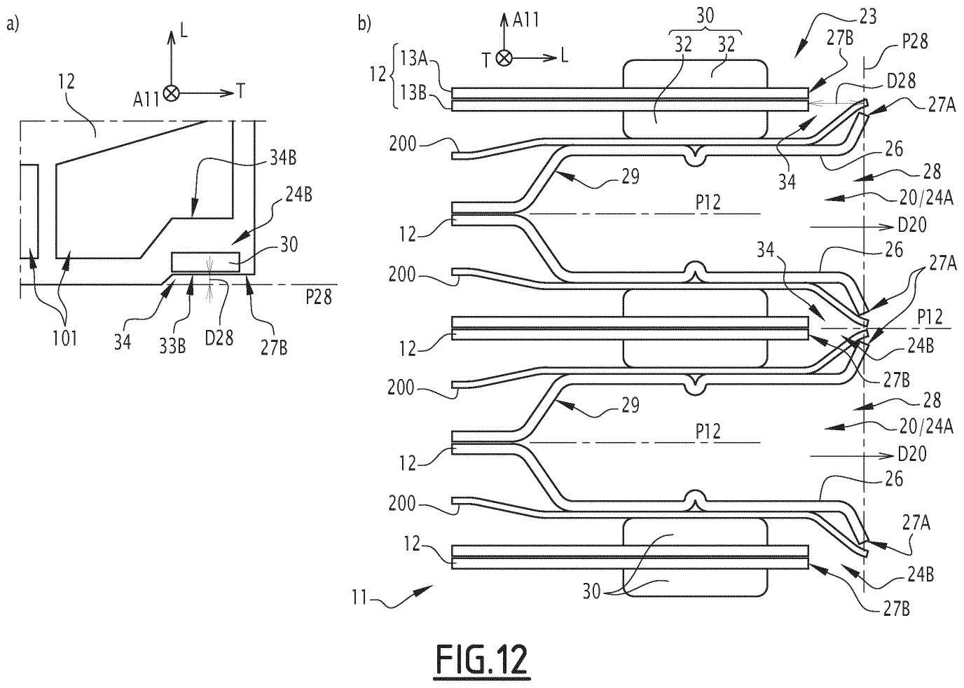

FIG. 12 schematically represents, on two inserts a) and b), a detail of a bipolar plate and a section of a stack belonging to the same fuel cell according to another embodiment of the invention;

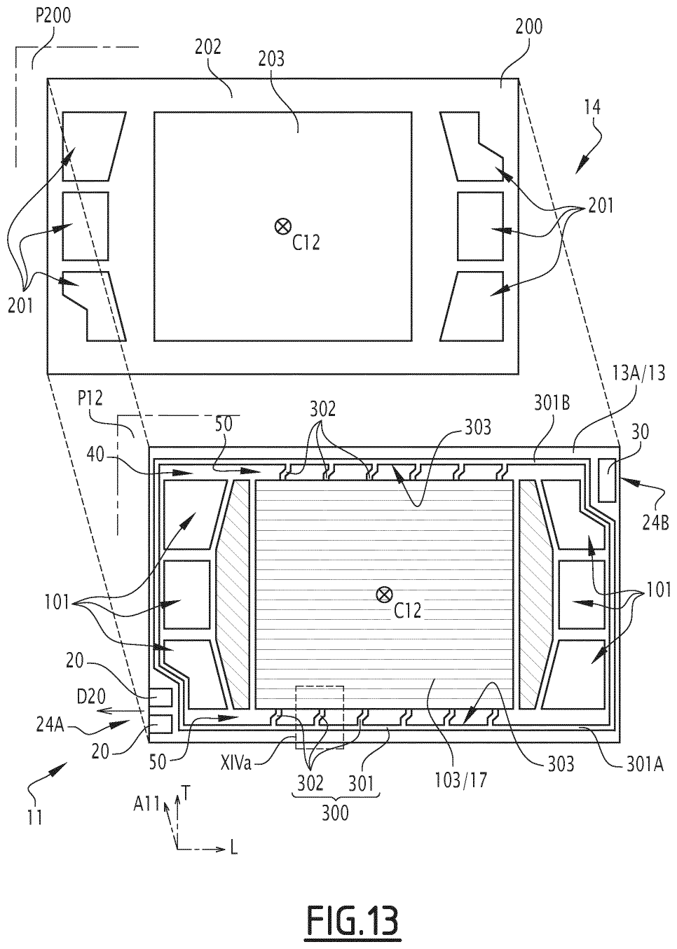

FIG. 13 schematically shows a perspective view of the stack shown in FIG. 1;

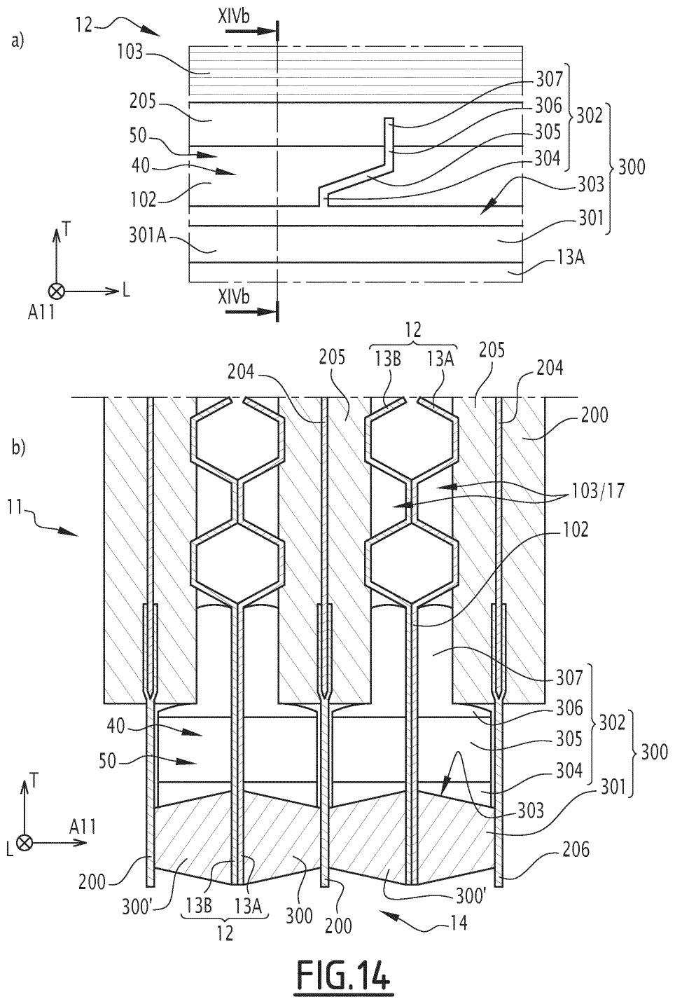

FIG. 14 shows, on two inserts a) and b), respectively, a top view of a detail of the stack of FIG. 13 and a section of a part of the stack of FIG. 13;

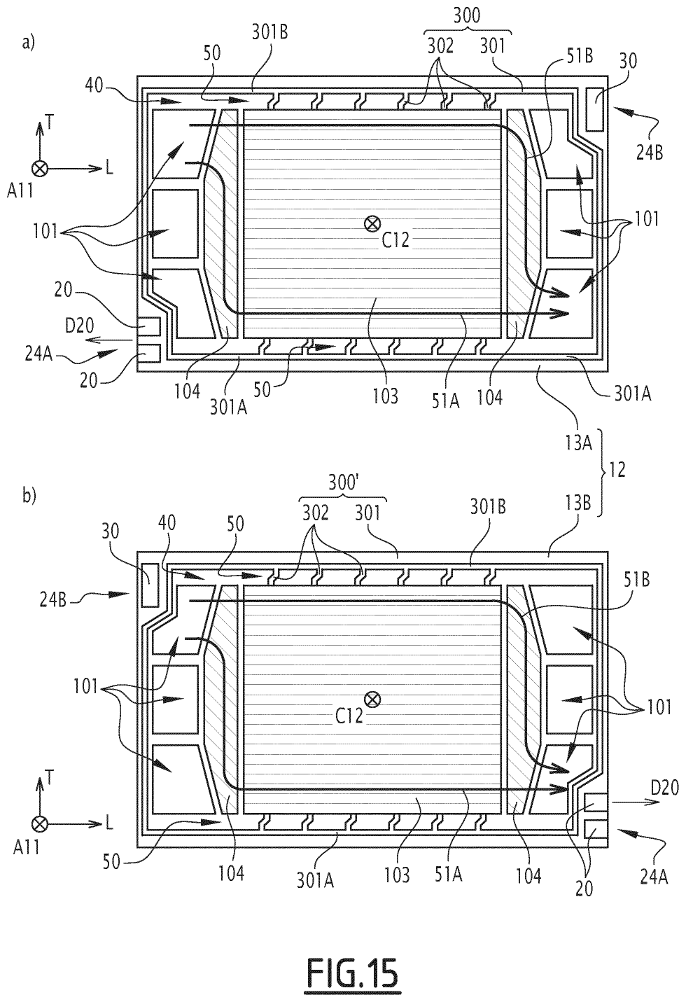

FIG. 15 shows, on two inserts a) and b), respectively, two opposite faces of a bipolar plate of the stack shown in FIG. 13, and

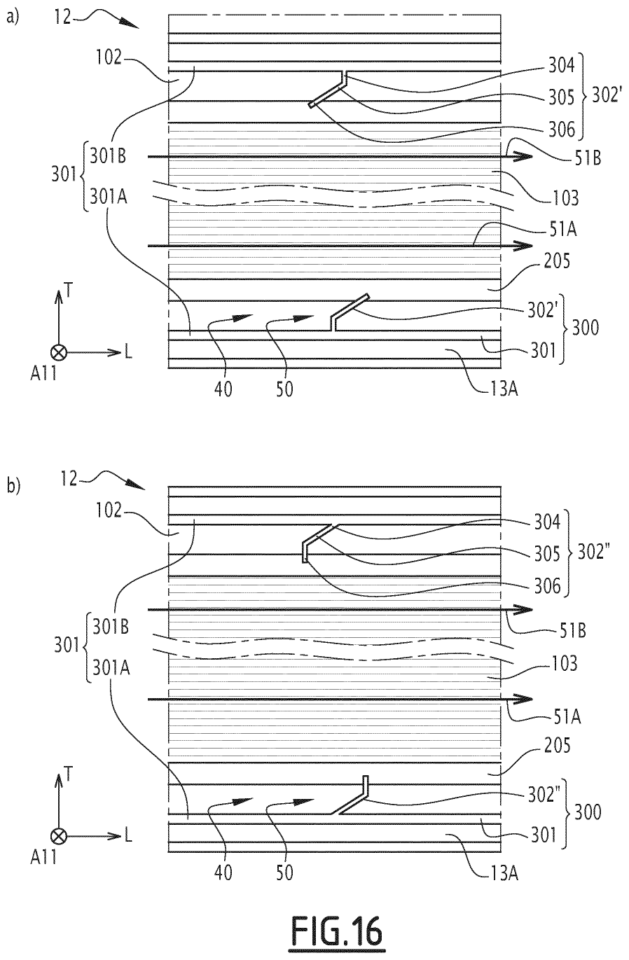

FIG. 16 shows, on two inserts a) and b), details of two bipolar plates belonging to fuel cells according to alternative embodiments of the invention.

FIGS. 1 and 2 show a fuel cell 10 according to a first embodiment of the invention. The fuel cell 10 comprises a stack 11 of bipolar plates 12.

In a known manner, each bipolar plate 12 has two opposite external faces: an anode face and a cathode face.

Each bipolar plate 12 is formed herein by two superimposed monopolar plates 13, the two monopolar plates 13 including a first polar plate 13A, herein a cathode plate, and a second polar plate 13B, herein an anode plate, the first and second polar plates 13A and 13B are visible in FIG. 5. The expression “two successive monopolar plates 13” refers to the two monopolar cathode plates 13A and anode plates 13B associated with the same bipolar plate 12. The monopolar plates 13 are also simply called “polar plates 13”. In such a bipolar plate 12 formed by two superimposed monopolar plates 13, the anode monopolar plate 13B forms the anode face of the bipolar plate 12, and the cathode monopolar plate 13A forms the cathode face of the bipolar plate 12.

A cooling circuit is advantageously arranged between the two monopolar plates, which are assembled to each other in a sealed manner. Each bipolar plate 12 has a substantially flat shape which extends along a median plane P12.

In such embodiment, the two monopolar plates 13 associated with the same bipolar plate 12 are made of metal and are welded or bonded together.

With reference to FIG. 4, the fuel cell 10 includes a plurality of cells 14 made in the form of a stack 11 of bipolar plates 12, a cell 14 being formed between two consecutive bipolar plates 12. A stack 11 thereby consists of a plurality of individual cells 14 connected in series. For each individual cell 14, the fuel cell 10 further comprises a membrane-electrode assembly 200, which is interposed between the two bipolar plates 12 associated with the cell 14. The membrane-electrode assembly 200 is also simply called MEA 200.

Each bipolar plate 12 is thereby common to two adjacent cells 14. Each membrane assembly 200 extends along a medium plane P200, which is parallel to the two median planes P12 associated with the bipolar plates 12 between which the membrane-electrode assembly 200 is interposed. The medium plane P200 is orthogonal to the axis of stacking A11.

The fuel cell 10 is e.g. intended to be used in a motor vehicle, more particularly an electric motor vehicle, the electrical energy supplying the engine being essentially, if not totally, supplied by the fuel cell 10.

The bipolar plates 12 are stacked along a direction of stacking A11. The direction of stacking A11 is orthogonal to the median plane P12 of the stacked bipolar plates 12. In other words, the median plane P12 is a plane transverse to the direction of stacking A11. A longitudinal direction L and a transverse direction T are also defined, which form with the direction of stacking A11 an orthogonal coordinate system.

The fuel cell 10 also comprises two end plates 16, which are arranged on each side of the stack 11. The stack 11 is sandwiched between the two end plates 16 and is compressed in the direction of stacking A11 between the end plates 16. The end plates 16 are e.g. made of aluminum.

External fluidic circuits (not shown) are linked to the cell 10 at the level of the end plates 16 and the reactive gases are distributed to the membrane-electrode assemblies 200 at the surface of the bipolar plates 12 via channels arranged on the latter and organized in a network of channels 17 comprising a flow field 103, and generally two homogenization fields 104, which will be discussed in detail hereinbelow. For each bipolar plate 12, a center C12 of the bipolar plate is defined, which corresponds herein to a center of symmetry of the network of channels 17.

In order to measure the electrical characteristics of the cells 14, e.g. an electrical voltage at the terminals of one or a plurality of cells 14, modules 18 for measuring at least one electrical characteristic of the cells 14 are connected to the stack 11 of bipolar plates 12. Each module 18 serves to monitor the state of the stack 11 in order to adapt the control of the fuel cell system 10.

Two successive monopolar plates 13, thus belonging to the same bipolar plate 12, are advantageously arranged back-to-back and form therebetween at least one pocket 20 on one edge of the bipolar plate 12, e.g. on an edge arranged at one end 21 of the bipolar plate 12 along the longitudinal direction L. The end 21 is thus here in the present example an edge of the bipolar plate 12, which extends parallel to the transverse direction T.

Each pocket 20 is configured to receive a pin 22 of a module 18 for measuring the electrical characteristics of the cells 14.

The bipolar plates 12 are identical to each other. Two successive bipolar plates 12 are stacked head-to-tail, as can be seen in FIG. 2, so that only the at least one pocket 20 of every two bipolar plates 12 is flush in the vicinity of the modules 18.

According to the example shown, each bipolar plate 12 forms exactly two pockets 20 for each receiving a pin 22. For each bipolar plate 12, the pockets 20 for receiving the bipolar plate 12 are arranged in the vicinity of one another, forming a connection zone 24A of the bipolar plate 12.

Each bipolar plate 12 also comprises a mating zone 24B. The mating zone 24B of the bipolar plate 12 is a portion of bipolar plate 12 wherein the constituent material of the plate extends, preferably a smooth portion. For each bipolar plate 12, the mating zone 24B is situated symmetrically opposite the connection zone 24A with respect to the center C12 of the bipolar plate 12. Thereby, for any two consecutive bipolar plates 12 of the stack 11, the connection zone 24A of one of the two plates 12 is arranged opposite, along the direction of stacking A11, the mating zone 24B of the other bipolar plate 12. For any three consecutive bipolar plates 12 of the stack 11, the connection zone 24A of one of the two plates 12, which is situated between the other two bipolar plates 12 which surround it in the direction of stacking A11, is arranged opposite, along the direction of stacking A11, of the mating zone 24B of each of the other two bipolar plates 12 which surround it in the direction of stacking A11.

As illustrated in FIG. 2, it should be understood that the stack 11 comprises two rows 23 of connection zones 24A, each of the rows 23 extending along the direction of stacking A11. The two rows 23 are located symmetrically relative to each other with respect to an axis parallel to the direction of stacking A11 and passing through the center C12 of each of the bipolar plates. In the example, the two rows 23 are located on either side of a transverse plane of the stack, the transverse plane being orthogonal to the longitudinal direction L. In the example illustrated, the modules 18 are connected to only one of the rows 23, located at the top of FIG. 2, the other row being left unused. In a variant (not shown), other modules such as the modules 18 are connected to the other row of connection zones 24A.

What is valid for one of the rows 23 of connection zones 24A can be transposed to the other row 23 of connection zones 24A. Hereinafter, the row 23 to which the modules 18 are connected is mainly described.

The second pocket 20 makes it possible to measure four wires per group of twenty cells 14. Same is used for measuring impedances.

More particularly, each pocket 20 is shaped to cooperate with said pin 22.

For each pocket 20, the two successive monopolar plates 13 delimit together, when same are in contact with each other, a circumferential wall 26 of the pocket 20.

Preferably, each pocket 20 has an open end 28 where the circumferential wall 26 has a conical shape. More generally, the open end 28 has a flared shape. Such a shape has the advantage of guiding the pin 22 of a module 18 during the insertion thereof into said pocket 20.

The open ends 28 of the same row 23 are geometrically supported by an opening plane P28, which is a plane parallel to the direction of stacking A11, in one example a transverse plane, in other words orthogonal to the longitudinal direction L.

It should be understood that each pin 22 is inserted into the corresponding pocket 20 according to an insertion movement, which is substantially a translational movement, oriented toward an internal volume of the corresponding pocket 20. For each pocket 20, a direction of connection D20 is defined, which corresponds substantially to an opposite direction of the insertion movement of the pin 22 in the pocket 20, and thus a direction parallel to the insertion movement but oriented along the opposite direction. For each pocket 20 of a given bipolar plate 12, each direction of connection D20 is parallel to the median plane P12 of the bipolar plate 12. Thereby, each pocket 20 opens outwards via the open end 28 of the pocket 20 along the direction of connection D20.

Preferably, the pockets 20 of the same connection zone 24A are oriented in the same direction, i.e. the direction of connections D20 associated with the pockets 20 are parallel to each other. Thereby, by extension, for each connection zone 24A, the direction of connection D20 of each pocket 20 associated with the connection zone 24A is also a direction of connection for the connection zone 24A. For each row 23 of connection zones 24A, the directions of connection D20 associated with the connection zones 24A are orthogonal to the opening plane P28 associated with the connection zones 24A.

Preferably, for any two consecutive bipolar plates 12, the direction of connection D20 of each pocket 20 of one of the two bipolar plates 12 is oriented opposite the direction of connection D20 of each pocket 20 of the other bipolar plate 12.

Advantageously, the circumferential wall 26 of each pocket 20 has a rib 26B so as to form a passage of small cross-section for a pin 22. The rib 26B clearances a role in stiffening the pocket 20 and makes it possible to ensure the electrical contact inside the pocket 20 between the pin 22 and the pocket 20.

Each module 18 herein includes ten aligned pins 22 configured to connect ten pockets 20 to said module 18, i.e. twenty cells 14, and an additional pin 25 to connect the second pocket 20 of one of the twenty cells 14, as can be seen in FIG. 3. The ten aligned pins 22 serve for measuring the voltage of two consecutive cells 14 between two consecutive pins 22. The pins 22, 25 of a module 18, are preferably identical.

In the embodiment shown, each connection zone 24A comprises two pockets 20, one of the pockets 20 being associated with one of the pins 22 of the module 18, whereas the other pocket 20 is configured to receive the additional pin 25.

The example shown comprises two modules 18, however the fuel cell 10 is not limited to two modules but may comprise more of same, e.g. ten modules 18 to connect two hundred cells 14. Similarly, the number of pins 22 for each module 10 is not limiting.

The additional pin 25 is arranged substantially parallel to the alignment of pins 20 and preferably at a longitudinal end of the module 18. For example, the additional pin 25 is configured to inject current into the pocket 20 wherein same is received, and thereby makes it possible to measure impedance on twenty cells 14.

With reference to FIG. 4, each bipolar plate 12, and by extension the two monopolar plates 13 associated with the bipolar plate 12, comprises openings 101, a peripheral zone 102, a flow field 103 and two homogenization fields 104. In other words, the elements 101 to 104 are on the two opposite faces of each bipolar plate 12. The flow field 103 and the two homogenization fields 104 are included in the channel network 17.

The peripheral zone 102 extends over the entire periphery of the bipolar plate 12, and herein borders the openings 101, the homogenization fields 104 and the flow field 103. The openings 101, the homogenization fields 104 and the flow field 103 are arranged inside the peripheral zone 102. The peripheral zone 102 extends in a plane perpendicular to the direction of stacking A11, i.e. in a plane parallel to the median plane P12.

Each opening 101 is intended either for the injection of reactive or cooling fluid, or for the discharge of reactive or cooling fluid, for each cell 12 of the stack 11. The reactive and cooling fluids are operating fluids of the fuel cell 10. The openings 101 have herein a closed contour, so the openings 101 form ducts internal to the stack 11, the ducts being called “internal manifold”. In a variant (not shown), the operating fluids of the fuel cell 10 are supplied by ducts external to the stack 11, the ducts being called “external manifolds”. In such case, the openings 101 have an open contour. The principles of the invention are valid regardless of the type of duct.

In the example, a row of three openings 101 is located on the one hand of the polar plate 13—herein the cathode plate 13A—with respect to the transverse direction T, the three openings 101 being aligned in the transverse direction T. Another row, comprising three other openings 101, is situated on the other hand of the polar plate 13, the other three openings 101 also being aligned in the transverse direction T. Each of the two rows of openings 101 is arranged close to a respective longitudinal end of the polar plate 13.

For each reactive or cooling fluid, and thus for each fluid flow field 103 of the cell 12, an opening 101 forms a fluid supply for the flow field concerned, and another opening, located symmetrically opposite with respect to the center C12, serves to discharge fluid for the flow field 103 concerned, the two openings 101 located symmetrically opposite with respect to the center C12 preferably having symmetrical geometries according to a central symmetry with respect to the center C12.

The flow field 103 extends, between the two homogenization fields 104 in the longitudinal direction L, over a face of the plate 13A oriented toward the membrane-electrode assembly 200. Each homogenization field 104 is arranged between the flow field 103 and the openings 101 along the longitudinal direction L. Each homogenization field 104 generally includes channels which link one of the openings 101 to the flow field 103. In the example illustrated, the channels of the homogenization fields 104 are similar and formed in the same way as the channels of the flow field 103, except for the orientation thereof, herein fanned out.

As an alternative (not shown), the channels of the homogenization fields 104 have a width and/or a depth different from the channels of the flow field 103. Similarly, the channels of the homogenization fields 104 can be made in a different way from the channels of the flow field 103, in particular with different technological methods. For example, the channels of the homogenization fields 104 are made in the form of ribs applied by the addition of metal, elastomer or polymer material to a portion of the polar plate 13, the portion being planar or not planar, whereas the channels of the flow field 103 can be made by deep-drawing, or vice versa.

For the cathode plate 13A, the first homogenization field 104 distributes the reactive fluid coming from one of the openings 101 so that same flows throughout the flow field 103, along the longitudinal direction L. The second homogenization field 104 serves to discharge the reactive fluid distributed over the entire flow field 103 as far as another opening 101, situated opposite the plate 13A, where the reactive fluid is discharged.

The two openings 101 linked by the flow field 103 and the two homogenization fields 104 are situated opposite each other with respect to the center C12, in other words the two openings 101 are arranged symmetrically with respect to the center C12. It should be understood that for each flow field 103, two symmetrical openings 101 opposite with respect to the center C12 are associated with the flow field 103, the two openings 101 serving the flow field.

For each reactive or cooling fluid, and thus for each fluid flow field of the cell, the two homogenization fields 104 are preferably symmetrical according to a central symmetry with respect to the center C12, both in the geometry of the homogenization fields 104 and in the arrangement of the channels of the homogenization fields 104.

In a variant (not shown), the polar plates 13 do not comprise the homogenization fields 104, the flow field 103 being directly linked to the openings 101.

Thereby, on the face of the plate 13A which is turned in the direction of the assembly 200, only one of the reactive fluids flows from one of the openings 101 to another of the openings 101 opposite along the longitudinal direction L, via the flow field 103. For the cathode polar plate 13A, the reactive fluid is a cathode reactive fluid, e.g. air or oxygen.

In the example illustrated, the membrane-electrode assembly 200—or MEA 200—comprises a peripheral portion 202, openings 201, and a central portion 203. The peripheral portion 202 extends throughout the periphery of the MEA 200 and borders the openings 201 and the central portion 203, which are located inside the peripheral portion 202. The openings 201 have a closed contour. The peripheral portion 202 extends in a plane perpendicular to the direction of stacking A11, parallel to the median plane P12.

The openings 201 of the MEA 200 are made in the membrane-electrode assembly 200 for the flow of the reactive fluids through the MEA along the direction of stacking A11. Each opening 201 extends one of the openings 101 of the cathode polar plate 13A along the direction of stacking A11, forming passage ducts (or manifolds) for the operating fluids of the fuel cell. In other words, the openings 101 and 201 face each other along the direction of stacking A11. In the example, each opening 201 has the same shape as the opening 101 same faces.

In the stack 11, the openings 101 of the bipolar plates 12 and the openings 201 of the membrane-electrode assemblies 200 together form ducts internal to the stack 11, also called “internal manifold”. In a variant (not shown), the operating fluids of the fuel cell 10 are supplied by ducts external to the stack 11, the ducts being called “external manifolds”. In such case, the openings 101 of the bipolar plates 12 each have an open contour. The principles of the invention are valid regardless of the type of manifolds.

The central portion 203 of the MEA 200 faces the flow field 103 and completely covers the flow field 103 along the direction of stacking A11. A peripheral periphery of the central portion 203 of the MEA 200 may, if appropriate, overlap an inner periphery of the peripheral portion 202 of the MEA 200.

With reference to FIG. 5, the central portion 203 of the MEA 200 comprises a membrane 204, which is a proton exchange polymer membrane. The membrane 204 extends parallel to the median plane P12, facing the flow field 103 in the direction of stacking A11, and is substantially flat. The membrane 204 is preferably coplanar with the peripheral portion 202 of the MEA 200. The membrane 204 may be covered with a layer of catalyst on the two faces thereof parallel to the median plane P12. In the example illustrated, the membrane 204 extends beyond the flow field 103, in particular in the case where the central portion 203 overlaps a portion of the peripheral portion 202.

The membrane 204 of each MEA 200 is taken between two gas diffusion layers (GDL) 205. Each diffusion layer 205 extends parallel to the median plane P12 and is interposed between the central portion 203 of the MEA 200 and the facing polar plate 13, along the direction of stacking A11. The central portion 203, taken between the GDL 205, is considered to extend along the medium plane P200.

The MEA 200 advantageously comprises a holding frame 206 for supporting the central portion 203, more particularly for supporting the membrane 204. The holding frame 206 then forms the peripheral portion 202. In the example shown in FIG. 5, the holding frame 206 clamps an outer peripheral periphery of the membrane 204, along the direction of stacking A11, in order to hold the membrane 204. The holding frame 206 then clamps the entire part of the membrane 204 which overlaps the peripheral portion 202 along the direction of stacking A11.

In a variant (not shown), instead of the holding frame 206, it would be possible to provide for the same membrane, such as the membrane 204, to form both the central portion 203 and the peripheral portion 202. However, the configuration shown is preferred, since the holding frame 206 is stronger, compared with the membrane 204, more flexible and more fragile. The holding frame 206 preferentially consists of two half-frames of substantially identical shapes which are intended to bear flat against each other and which are e.g. made of polymer film, e.g. polyethylene terephthalate, known by the abbreviation PET, or polyethylene naphthalate, known as PEN. In the latter case, the two half-frames are e.g. assembled to each other by bonding.

In the example illustrated, each diffusion layer 205 entirely covers the facing central portion 203, more particularly covers the membrane 204, and advantageously projects over the peripheral portion 202, namely over the inner periphery of the holding frame 206 pinching the membrane 204. In particular, the gas diffusion layer 205 bears, at least in the zone corresponding to the flow chamber 103, against the network of channels 17 along the direction of stacking A11 and bears against the membrane 204 along the opposite direction. The gas diffusion layer 205 is advantageously formed of a porous material and allows the reactive fluid to diffuse from the channels 17 to the membrane 204 when the cell 14 is in operation, and, if appropriate, to reaction products coming from membrane 204 to diffuse as far as the channels 105 so as to be discharged.

Each pin 22, 25 of the module 18 is designed to promote an effective and durable electrical contact over time between the module 18 and the bipolar plate 12 to which same corresponds. To this end, each pin 22, 25 of the module 18 has, e.g., a shape such that the pin 22, 25 exerts two opposite forces on the circumferential wall 26 of the pocket 20 once the pin 22, 25 has been inserted into the corresponding pocket 20. With reference to FIG. 5, it will be understood that when the pins 22, 25 are inserted into the corresponding pockets 20, the two polar plates 13A and 13B which form the corresponding bipolar plate 12 tend to move apart from each other.

The stack 11 further comprises wedging means 30, which are arranged between each connection zone 24A and the mating zone 24B opposite, so as to limit the deformations of each pocket 20 of the connection zone 24A when the pin 22 associated with the pocket 20 is inserted into the pocket 20. More particularly, so as to limit the aptitude of the polar plates 13A and 13B to move apart during the insertion of the pins 22, 25. Preferably, the wedging means 30 are aligned, along the direction of stacking A11, with each of the pockets 20. Preferably, the wedging means 30 are arranged on both sides of the chamber 20 along the direction of stacking A11.

In the example of FIG. 5, for each bipolar plate 12, the wedging means 30 comprise two spacers 32, e.g. having two opposite faces parallel to the median plane P12, e.g. of parallelepiped shape. Preferably, each spacer 32 is fastened to the mating zone 24B and is thereby interposed between the mating zone 24B and the connection zone 24A situated opposite. For a given bipolar plate 12, the mating zone 24B thereby includes a spacer 32 on the anode face of the bipolar plate 12 and a spacer 32 on the cathode face of the bipolar plate 12. In the present example, the spacers are made of an electrically insulating material. Moreover, it may be advantageous for the spacers to be made of an elastic material, more particularly of elastomer, and thus in particular of electrically insulating elastomer. The spacers 32 are herein made of polysiloxane, also called silicone, and are fastened to the monopolar plates 13 associated with the bipolar plate, before forming the stack 11. For example, silicone paste is applied to the monopolar plates 13, the silicone forming, after hardening, the spacers 32. In particular, the spacers 32 are advantageously made by overmolding on the monopolar plates 13. Thereby, each spacer 32 is advantageously fastened directly, by overmolding, to the corresponding mating zone 24B. Alternatively, spacers are manufactured beforehand, e.g. by molding and/or machining, the spacers then being bonded or nested onto the monopolar plates 13, and thereby forming the wedging means 30.

Once the cells 14 have been stacked in an operational state of the cell 10, the wedging means 30 bear against the two facing bipolar plates 12, or at a very short distance from each of the two facing bipolar plates 12, each wedging means 30 being thereby interposed between a connection zone 24A of one of the two bipolar plates 12, and the mating zone 24B situated opposite and belonging to the other two bipolar plates 12. In the case of a spacer 32 made of elastic material, in particular, when inserting the pin 22 or 25 into a pocket 20, the wedging means 30 arranged on either side of the connection zone 24A associated with the pocket 20 can be made to deform elastically to accommodate the passage of the pin into the pocket 20, while resisting, by elastic return, the moving apart of the polar plates 13 associated with the pocket 20, by bearing against the adjacent bipolar plates 12, more particularly by bearing against the mating facing zones 24B.

An interval L12 is defined as being a distance between two adjacent bipolar plates 12, measured between the median planes P12 of two successive bipolar plates 12 parallel to the axis of stacking A11. The interval L12 corresponds to the pitch of the fuel cell 10, in other words to the average thickness of a cell 14. The interval L12 is comprised e.g. between 0.8 mm and 1.5 mm.

According to examples, the wedging means 30 have a thickness, measured parallel to the direction of stacking A11, less than the interval L12 separating the two facing bipolar plates 12 in the operational state of the stack, in order, despite any slight separation of the polar plates 13 associated with the pocket 20, to accommodate the passage of the pin into the pocket 20, while limiting the separation, in particular in order to take account of the geometrical tolerances of manufacture and of assembly of the cells.

In particular, the wedging means 30 keep the two adjacent bipolar plates 12 at a distance, in particular keep at a distance each connection zone 24A from the mating zones 24B situated opposite. The wedging means 30 prevent any direct contact between the two adjacent bipolar plates 12, more particularly prevent any direct contact between each connection zone 24A and the mating zones 24B situated opposite.

Advantageously, in an operational state of the stack 10, the wedging means 30 are dimensioned in terms of thickness, along the direction of stacking A11, so as to thereby leave, between the wedging means 30 and the two adjacent bipolar plates 12, a total dimensional clearance along the direction of stacking A11. The dimensional clearance is preferably less than 100 microns, more preferentially less than 50 microns. The dimensional clearance between the wedging means and the adjacent bipolar plates 12 is not shown in the figures. Due to the dimensional clearance, it is possible to accept dispersions in size of the wedging means 30 and of the bipolar plates 12 without any risk that the wedging means, which would be too thick with respect to the space available between a connection zone 24A and the mating zones 24B, causing a local deformation of the bipolar plates 12.

With reference to FIG. 5, where the stack 11 is shown in section, for each pocket 20 of a given connection zone 24A, the circumferential wall 26 advantageously comprises flared rims 27A which delimit the open end 28 of the pocket 20. The flared rims 27A correspond to the edges of the monopolar plates 13A/13B and extend herein parallel to the transverse axis T. The rims 27A diverge with respect to the median plane P12 as we move away from a bottom 29 of the pocket 20. Each flared rim 27A is a portion of an outer edge of the bipolar plate 12 to which the connection zone 24A belongs. The flared rims 27A facilitate the insertion of the pin 22/25 corresponding to the pin 20 in question.

For each pocket 20, an overall size L20 is defined as being a maximum distance, measured parallel to the axis of stacking A11, between the two flared rims 27A of the pocket 20. The overall size L20 and the interval L12 are shown in FIG. 5. The head-to-tail mounting of the bipolar plates 12 makes it possible to provide pockets 20 the overall size of which LO is greater than the interval L12, which facilitates the insertion of the pins 22, which are thicker and thus more solid.

Each mating zone 24B comprises a mating edge 27B which extends facing the adjacent flared rims 27A, preferably parallel to the adjacent flared rims 27A belonging to the connection zone or zones 24A facing the mating zone 24B. Each mating edge 27B is a portion of an outer edge of the bipolar plate 12 to which the mating zone 24B belongs. Each mating edge 27B herein extends parallel to the transverse direction T.

In the examples illustrated in FIGS. 5 to 8, the flared edges 27A and the mating edges 27B are aligned with one another along the direction of stacking A11. In other words, the flared rims 27A and the mating edges 27B are geometrically carried by the opening plane P28.

It should be understood that the wedging means 30 serve to keep at a distance each flared rim 27A from the neighbor mating edge(s) 27B, which reduces the risks of short-circuiting between two neighbor bipolar plates 12.

As illustrated in FIG. 5, for each cell 14, the membrane-electrode assembly 200 is advantageously pinched by the wedging means 30 between the two bipolar plates 12 associated with the cell 14. In the example shown in FIG. 5, the holding frame 206 is pinched by the wedging means 30 between the two bipolar plates 12.

In general, and including for the embodiments described hereinbelow, one or a plurality of the spacers 32 may be formed by a portion of a seal of the cell 14. Similarly, one or a plurality of the spacers 32 may be distinct from the seals but may be made of the same material as at least one of the seals of the cell. In the two cases, the spacer 32 is then preferably made during the same operation as the formation of the seal, e.g. during the same casting, molding or overmolding operation as the seal in question, whether the seal is rigidly attached to one of the monopolar plates 13, to the MEA 200 or whether the seal in question is a free seal.

A stack 211 according to an alternative embodiment of the invention is shown in FIG. 6.

In the alternative embodiments of the invention, the elements analog to the elements of the other embodiments have the same references and work in the same way. The differences between each embodiment and the preceding embodiment or embodiments is described hereinafter.

Compared to the stack 11 of the preceding embodiment wherein the bipolar plates 12 are formed by two monopolar plates 13 welded or bonded together in a sealed manner, the case of the stack 211 shown in FIG. 6 is an example wherein each bipolar plate 12 is formed of two monopolar plates 13 which are assembled by simple compression against each other, because of the assembly with the interposition of an attached seal 230, which is arranged between the two monopolar plates 13. The directly mounted seal 230 is shown diagrammatically and in a non-limiting manner by a rectangle in dotted lines.

In the example shown in FIG. 6, for each bipolar plate 12, the wedging means 30 comprise three spacers 32, e.g. made of elastomer material, in particular silicone, two of the spacers 32 being arranged on each side of the mating zone 24B of the bipolar plate 12, on the anode face of the bipolar plate 12 and on the cathode face of the bipolar plate 12, respectively, while the third spacer 32 is arranged between the two cathode and anode plates 13A and 13B forming the bipolar plate 12, preferably also in the mating zone of the bipolar plate 12. Preferably, the three spacers 32 are aligned along the axis of stacking A11, so as to take up the compressive forces parallel to the axis of stacking A11.

A stack 311, according to a second embodiment of the invention, is shown in FIG. 7. Compared with the previous embodiments, in the case of the stack 311 shown in FIG. 7, the monopolar plates 13A and 13B of each bipolar plate 12 comprise bulges 332 which extend at a distance from the median plane P12 associated with the bipolar plate 12, the bulges 332 being provided in the mating zone 24B and bearing onto the pockets 20 of the facing connection zone 24A. The bulge 332 forms a relief on the corresponding face of the bipolar plate 12. Thereby, the bulges 332 form the wedging means 30. For each bipolar plate 12, the associated monopolar plates 13A and 13B are herein welded together. As described hereinabove, the dimensioning of the bulges 332 along the direction of stacking A11 preferentially provides a dimensional clearance allowing the manufacturing and assembly tolerances of the cells 12 to be accommodated.

The bulges 332 are advantageously formed together with the formation of the channels 17, more particularly are formed by stamping. The bulges 332 are provided in one-piece with each of the monopolar plates 13A/13B. By extension, the wedging means 30 are herein formed in one-piece with the bipolar plates 12, which is economical and quick to produce.

A stack 411, according to a second embodiment of the invention, is shown in FIG. 8. With respect to the preceding embodiments, more particularly with respect to the stack 11 shown in particular in FIG. 5, in the case of the stack 411 shown in FIG. 8, the spacers 32 of the wedging means 30 associated with each bipolar plate 12, and which are arranged on the anode face of the bipolar plate 12 and on the cathode face of the bipolar plate 12 respectively, are linked to each other by a bridge of material 434. The wedging means 30 are mounted on an edge of the bipolar plate 12 concerned, more precisely on the mating edge 27B of the bipolar plate 12 concerned, so that the spacers 32 are situated on each side of the mating zone 24B, i.e. on each face of the bipolar plate 12.

In the example illustrated, the bridge of material 434 is a flexible wall which links the spacers 32 to each other. Preferably, the bridge of material 434 is formed by a continuous wall and covers the entire mating edge 27B facing the connection zone 24A, so as to electrically insulate the mating edge 27B from the opposite flared rim or flared rims 27A.

Preferably, the bridge of material 434 is preformed so as to slightly pinch the mating edge 27B of the bipolar plate 12 and to hold the wedging means 30 in position on the mating zone 24B during the assembly of the stack 511. Advantageously, the wedging means 30 are bonded to the bipolar plate 12.

In a variant (not shown), the mating zone 24B comprises openings, e.g. drilled holes, whereas the wedging members 30 comprise protuberances of mating shape to the openings, e.g. studs mating to the drilled holes, the openings and the mating protuberances cooperating with each other by shape matching, so as to facilitate the positioning of the wedging members 30 when same are mounted on the corresponding mating zone 24B.

A stack 511, according to a second embodiment of the invention, is shown in FIG. 9. With respect to the preceding embodiments, more particularly with respect to the stack 11 shown in particular in FIG. 5, in the case of the stack 511 shown in FIG. 9, the spacers 32 are fastened to the membrane-electrode assembly 200 rather than to the monopolar plates 13A/13B. In the example illustrated, the spacers 32 are fastened to the holding frame 206 of the MEA 200. Once the stack 511 has been formed, the spacers 32 are situated between each connection zone 24A and the mating zone or zones 24B facing each other, forming the wedging means 30.

In the example illustrated, each spacer 32 is positioned on one side of the membrane-electrode assembly 200, preferably on the side oriented toward the mating zone 24B, which serves to reduce the offset, along the direction of stacking A11, of the peripheral portion 202 of the MEA 200 with respect to the medium plane P200, which reduces the risk of tearing of the membrane-electrode assembly 200. Preferably, each spacer 32 bears onto a flat portion of the mating zone 24B. As described hereinabove, the dimensioning of the spacers 32 along the direction of stacking A11 advantageously provides a dimensional clearance allowing the tolerances of manufacturing and assembly of the cells to be accommodated.

A stack 611, according to a second embodiment of the invention, is shown in FIG. 10. With respect to the preceding embodiments, in particular with respect to the stack 511 shown in particular in FIG. 9, in the case of the stack 611 shown in FIG. 10, each spacer 32 comprises two half-spacers 33, which are fastened on each side of the membrane-electrode assembly 200, in correspondence with each other along the direction of stacking A11, which provides a better distribution of the forces on the membrane-electrode assembly 200 and reduces the risks of tearing the membrane-electrode assembly 200.

With reference to FIG. 11a), for each bipolar plate 12, the mating zone 24B is situated symmetrically opposite the connection zone 24A with respect to the center C12 of the bipolar plate 12. The connection zone 24A and the mating zone 24B each have a profile, in projection onto the median plane P12.

The profile of the connection zone 24A thus includes the flared rim 27A, which is herein seen from above, and which forms an external portion 33A of the profile of the connection zone 24A. In the example illustrated, the connection zone 24A extends close to one of the openings 101 of the bipolar plate 12, here one of the openings 101 located at the end of one of the two rows of three openings 101, the connection zone 24A forming an internal portion 34A of the profile of the connection zone 24A.

Similarly, the profile of the mating zone 24B includes the mating edge 27B, which is herein seen from above, and which forms an external portion 33B of the profile of the mating zone 24B. The mating zone 24B extends close to one of the openings 101 of the other row of three openings 101, forming an internal portion 34B of the profile of the mating zone 24B.

Preferably, the internal profile of the connection zone 24A is symmetrical, with respect to the center C12, to the internal profile of the mating zone 24B. Thereby, when two bipolar plates are stacked head-to-tail, the internal profile of the connection zone 24A of a first of the two bipolar plates 12 is superimposed on the internal profile of the mating zone 24B of the other bipolar plate 12.

Preferably, the external profile of the connection zone 24A is symmetrical, with respect to the center C12, to the external profile of the mating zone 24B. The monopolar plates 13A and 13B are thereby easy to manufacture.

In the example shown in FIG. 11b), the connection zones 24A and mating zones 24B are arranged differently with respect to the bipolar plate 12 of FIG. 11a), the connection zones 24A and the mating zones 24B extending close to the opening 101 in the middle of the corresponding row of three openings 101.

An advantageous variant of the bipolar plate 12 is shown in FIG. 12. According to said variant, an outer edge of each mating zone 24B is situated set back from the opening plane P28. In the example illustrated, the mating zone 24B has a notch 34 so that the external profile 33B of the mating zone 24B is set back from the external profile 33A of the connection zone 24A. The shape of the notch 34 is not limiting. In the example illustrated, each mating edge 27B is parallel to and at a distance from the opening plane P28. For each mating edge 27B, a distance D28 is defined as a minimum distance, parallel to the median plane P12, between the mating edge 27B and the facing opening plane P28. By extension, the distance D28 is also a distance between each mating zone 24B and the opening plane P28, in other words a distance between each mating zone 24B and the flared rims 27A.

In the example shown in FIG. 12, the external profile 33B is rectilinear, so the distance D28 is simply the distance between the mating edge 27B and the opening plane D28. In the preceding embodiments, the distance D28 is zero, or substantially zero.

By means of the setting back, it is possible to enlarge the flaring of the flared rims 27A, along the direction of stacking A11, which facilitates the insertion of the pins 22/25, while maintaining a minimum distance between each flared rim 27A and the mating edge 27B associated with the flared edge 27A, reducing the risks of short circuits, in particular during the connection of the modules 18.

Each mating edge 27B is thereby set back from the opening plane 28, the distance D28 being greater than or equal to 1 mm, else preferably greater than or equal to 2 mm, while being preferably less than 5 mm.

Another aspect of the invention is described with reference to FIGS. 13 to 15. Attention is paid, more particularly, to the sealing, within each cell 14, between the monopolar plates 13 and the membrane-electrode assembly 200. The stack 11 is partially shown in FIG. 13, a monopolar plate 13, herein a cathode plate 13A, and a membrane-electrode assembly 200 being visible.

The cathode plate 13A and the membrane-electrode assembly 200 form part of a cell 14, which also comprises a peripheral seal 300, also called the first seal, which is interposed between the cathode polar plate 13A and the MEA 200, along the direction of stacking A11. The peripheral seal 300 comprises a main part 301 and fins 302. The peripheral seal 300 is preferentially made of an elastomer material and impermeable to the cathode fluid used in the fuel cell 10. More generally, the peripheral seal 300 is impermeable to each of the operating fluids of the fuel cell 10.

With reference to FIG. 14b), for each anode plate 13B, the stack 11 comprises a peripheral seal 300′, which is interposed between the anode plate 13B and the membrane-electrode assembly 200 situated opposite the anode plate 13B. The principles of the invention described in relation to the peripheral seals 300 associated with the cathode plates 13A can be transposed to the peripheral seals 300′ associated with the anode plates 13B. The peripheral seals 300 associated with the cathode plates 13A are described hereinafter.

In the example illustrated, the first peripheral seal 300 is formed on the cathode polar plate 13A, e.g. by overmolding on the cathode polar plate 13A. Alternatively, the peripheral seal 300 is formed on the MEA 200, or even is formed separately from the cathode polar plate 13A and of the MEA 200.

The main part 301 is a bead of material which extends continuously and forms a closed contour, in other words a closed loop which, in the present example, extends along the peripheral zone 102 over the entire periphery of the plate 13A. The main part 301 surrounds the flow field 103, the homogenization fields 104 if same are provided, and the openings 101 serving the flow field 103. In the example illustrated, the main part 301 has a trapezoidal cross-section, such shape not being limiting. The main part 301 comprises two longitudinal portions 301A and 301B, which run along the flow field 103 and which herein extend parallel to the longitudinal direction L.

In the example illustrated, the main part 301 of the peripheral seal 300 advantageously surrounds all the openings 101 of the plate 13A. In a variant (not shown), other seals are provided around the openings 101 which do not serve the flow field in question.

However, the main part 301 surrounds neither the connection zone 24A nor the mating zone 24B.

When the cathode plate 13A and the membrane-electrode assembly 200 are assembled within the stack 11, the main part 301 extends in a closed loop along the peripheral portion 202, herein along the holding frame 206, throughout periphery of the peripheral portion 202. The main part 301 is interposed between the peripheral zone 102 and the peripheral portion 202 along the direction of stacking A11, so as to seal the space defined along the direction of stacking A11 between the peripheral zone 102 of the cathode plate 13A and the peripheral portion 202 of the MEA 200, over the entire periphery. The main part 301 also surrounds the gas diffusion layer 205, and the face of the membrane 204 oriented toward the cathode plate 13A.

When the cathode plate 13A and the membrane-electrode assembly 200 are assembled within the stack 11, the main part 301, the cathode polar plate 13A and the MEA 200 delimit therebetween a compartment 40, herein a cathode compartment. The main part 301 provides a sealing of the cathode compartment 40 with respect to the outside of the cell 14, in particular an external zone 3 situated beyond the main part 301 with respect to the cathode compartment 40. The connection zone 24A and the mating zone 24B are located outside the cathode compartment 40, the pockets 20 remaining accessible for the connection thereof to the modules 18. Each cell 14 thus comprises two compartments 40 which are associated with the cathode plate 13A and with the anode plate 13B, respectively, delimiting the cell 14.

The main part 301 of the first peripheral seal 300 comprises two opposite internal longitudinal surfaces 303, each arranged transversely on each side of the flow field 103, each internal longitudinal surface 303 extending over a longitudinal portion 301A or 301B of the main part 301, being oriented toward the direction of the flow field 103. Each internal longitudinal surface 303 links the peripheral zone 102 of the cathode polar plate 13A to the peripheral portion 202 of the MEA 200 in the direction of stacking A11.

Each cathode compartment 40 includes two portions called “bypass zones 50” which extend between the peripheral seal 300 and the flow field 103 and which link the openings 101 serving the flow field 103. More particularly, each bypass zone 50 extends between a respective longitudinal portion 301A or 301B and the flow field 103. Schematically, each bypass zone 50 corresponds to a bypass path around the flow field 103, which the reactive fluid follows between the two openings 101 serving the flow field 103.

Each bypass zone 50 is delimited, along the direction of stacking A11, between the cathode polar plate 13A and the MEA 200, and is delimited, along the transverse direction T, between, on the one hand, the flow field 103 and the gas diffusion layer 205 and, on the other hand, the main part 301 of the peripheral seal 300, for a portion of the main part 301 which extends along the longitudinal direction L. Each bypass zone 50 extends, along the longitudinal direction L, along the flow field 103, or even from one homogenization field 104 to the other. The flow field 103 extends between the two bypass zones 50 along the transverse direction T.

The function of the fins 302 is to reduce or even prevent a reactive fluid from flowing along the longitudinal direction L in the bypass zones 50. To this end, each fin 302 at least partially shuts off a cross-section of the bypass zone 50 which same occupies, the cross-section being taken perpendicularly to the longitudinal direction L. The fins 302 are distributed along the main part 301 of the seal 300, in one or the other or both cathode bypass zones 50. Each fin 302 is attached to one of the internal surfaces 303 of the main part 301. In the example illustrated, the fins 302 protrude from each of the longitudinal portions 301A and 301B of the main part 301. Each fin 302 extends from the internal surface 303, overall along the transverse direction T, and toward the direction of the flow field 103. Preferably, the fins 302 are formed in one-piece with the main part 301.

Each fin 302 comprises, successively and starting from the main part 301, a junction part 304, an intermediate part 305 and an end part 306.

Each fin 302 is, in the examples illustrated, advantageously in the form of a wall which has, in the plane, an elongation in the median plane P12 between the junction part 304 thereof and the end part 306 thereof, the elongation having a rectilinear, broken or curved line profile, or a profile consisting of a combination of one or a plurality of straight lines and/or one or a plurality of broken lines, and/or one or a plurality of curves.

The fin 302 is coupled to the main part 301 by means of the junction part 304, which extends from the internal surface 303. In the present example, the junction part 304 is rectilinear and the projection onto the median plane P12 is perpendicular to the longitudinal direction L, i.e. parallel to the transverse direction T. The junction part 304 is interposed along the direction of stacking A11 between the peripheral zone 102 of the polar plate 13 and the peripheral portion 202 of the MEA 200.

The intermediate part 305 of the fin 302 is attached to the junction part 304, continuing same along the direction of the field 103. In the present example, the intermediate part 305 is rectilinear and the projection thereof onto the median plane P12 is oblique with respect to the longitudinal direction L. The intermediate part 305 is interposed along the direction of stacking A11 between the peripheral zone 102 and the peripheral portion 202. In a variant, provision can be made for the intermediate part 305 to be parallel to the longitudinal direction L, i.e. parallel to the main part 301. More generally, the intermediate part 305 is inclined with respect to the transverse direction T, i.e. inclined with respect to a direction orthogonal to the longitudinal portion 301A or 301B to which the corresponding fin 302 is attached.

The end portion 306 of the fin 302 is attached to the intermediate portion 305, continuing same toward the field 103. The end portion 306 ends the fin 302. In the present example, the end portion 306 is rectilinear and the projection thereof onto the median plane P12 is perpendicular to the longitudinal direction L, i.e. is parallel to the transverse direction T.

At least one portion of the end portion 306 of the fin 302, called the contact portion 307 and including a free end of the fin 302, is interposed between the gas diffusion layer 205 and the peripheral zone 102 along the direction of stacking A11. If appropriate, another portion of the end portion 306, through which the end portion 306 is attached to the intermediate portion 305, is interposed between the peripheral zone 102 and the peripheral portion 202.

In the example illustrated, the end part 306 and the intermediate part 305 form therebetween an angle advantageously comprised between 110° and 150°, herein an angle of 120°. The intermediate part 305 and the junction part 304 form therebetween an angle advantageously comprised between 110° and 150°, herein an angle of 120°.

As shown in FIG. 14b), the contact portion 307 of the fin 302 is elastically deformed, in compression along the direction of stacking A11, between the gas diffusion layer 205 and the peripheral zone 102. Since the contact portion 307 is thereby compressed, same has a thickness, measured along the direction of stacking A11, which is less than that of the rest of the fin 302, in particular to the thickness of the junction portion 304 and of the intermediate portion 305. In the non-deformed state of the fin 302, provision can be made for the portion 307 to initially have the same thickness along the direction of stacking A11 as the rest of the fin 302. Such deformation under compression of the contact portion 307 can also deform the intermediate portion 305. As illustrated, the intermediate part 305 takes up the deformation of the end part 306 by twisting slightly. The fact that the intermediate part 305 is inclined with respect to the transverse direction T prevents mechanical stresses, related to the flattening of the contact zone 307 between the layer 205 and the peripheral zone 102, from being applied to the main part 301, which would adversely affect the sealing of the peripheral seal 301 and/or the longevity thereof.

Under certain conditions of use of the fuel cell 10, in particular during a cold start-up of the fuel cell 10, it may happen that water vapor condenses into liquid water within the compartments 40. When the fuel cell 10 is in use, e.g. in a vehicle, the stack 11 is generally laid out lying down, i.e. the stack direction A11 is substantially horizontal-when the vehicle rests on a horizontal surface-whereas the transverse direction T of the stack is substantially vertical. The two longitudinal portions 301A and 301B are then horizontal, one of the longitudinal portions 301A/301B of the peripheral seal 301 being situated above the other longitudinal portion 301B/301A of the peripheral seal 301. In the example illustrated in FIGS. 13 and 15a, the longitudinal portion 301A of the peripheral seal 301, at the bottom of FIG. 13, is located below the other longitudinal portion 301B of the same peripheral seal 301. The condensation water then tends to accumulate against same of the longitudinal portions 301A or 301B of the peripheral seal 301 which is at the bottom.

In the example shown in FIGS. 13 and 15a), the cathode plate 13A is visible, and the cathode fluid is assumed to flow from one of the openings 101 located on the left of FIG. 13 to one of the openings 101 located on the right of FIG. 13. For example, the reactive fluid flows from the opening 101 located at the top left of the cathode plate 13A to the opening 101 located at the bottom right. Thereby, the reactive fluid flows along the bypass zones 50 overall along the same direction, herein to the right along the longitudinal direction L. The circulation of the reactive fluid along the bypass zones 50 is represented schematically by two arrows 51A and 51B in FIG. 15a).

The fins 302 of the bottom longitudinal portion 301A are advantageously oriented along the direction of flow of the reactive fluid flowing along the bypass zone 50 associated with the bottom longitudinal portion 301A, so as to facilitate the discharge of the condensation water, entrained by the reactive fluid. In other words, the fins 302 of the longitudinal portion 301A of the bottom are inclined along the same direction with respect to the transverse direction T, along the direction of flow of the reactive fluid.

On the other hand, as mentioned hereinabove, two consecutive bipolar plates 12 of the stack 11 are stacked head-to-tail. With reference to FIGS. 13 and 15a, thereof is equivalent to taking a first bipolar plate 12 along the same orientation as shown in said figures, then taking a second bipolar plate 12 rotated at 180° about the direction of stacking A11—which amounts to obtaining a symmetry with respect to the center C12—. In other words, the longitudinal portion 301B, shown at the top in FIGS. 13 and 15a), is at the bottom—such configuration not being shown—.

Advantageously, for each peripheral seal 301, the fins 302 attached to opposite longitudinal portions 301A, 301B are inclined along opposite directions with respect to the transverse direction T, so that even when the bipolar plates 12 are arranged head-to-tail, the fins 302 of the longitudinal portion 301A or 301B which is at the bottom are inclined along the direction of flow of the reactive fluid. Thereby, the fins 302 attached to the longitudinal portion 301B at the top are inclined, with respect to the transverse axis T, along the opposite direction to the flow of the reactive fluid.

The two opposite faces of the same bipolar plate 12 are shown on inserts a) and b), respectively of FIG. 15, the cathode plate 13A being shown on insert a), whereas the anode plate 13B is shown on insert b). In other words, between the inserts a) and b), the same bipolar plate 12 is turned upside down, by rotation through 180° about the transverse axis T, which is vertical in FIG. 15.

The principles of the invention defined with reference to the cathode plate 13A of FIG. 15a) are of course valid for anode plate 13B of FIG. 15b), i.e. the fins 302 of the longitudinal portion of the bottom—herein the longitudinal portion 301B—are inclined, with respect to the transverse axis T, along the same direction as the direction of flow of the reactive fluid associated with the anode plate 13B. Thereby, the fins 302 belonging to the same longitudinal portion 301A or 301B are inclined along the same direction with respect to the transverse direction T.

It should be understood that the direction of inclination of the fins 302 belonging to the longitudinal portion 301A of the bottom is chosen according to the direction of flow of the reactive fluid along the corresponding bypass zone 50. In the example illustrated, the flows of reactive fluids are crossed on both sides of each bipolar plate 12, which means that when the polar plates 13A and 13B are seen from the front, the flows are represented in the same direction, as shown in FIGS. 15a) and b).

Advantageously, for the peripheral seal 301 of the anode plate 13B, the fins 302 belonging to opposite longitudinal portions 301A/301B are inclined along opposite directions with respect to the transverse direction T.

Peripheral joints 300 comprising fins 302 and 302″ of two alternative types are shown in FIGS. 16a) and 16b), respectively. As before, it is assumed that the reactive fluid flows from left to right.

In FIG. 16a), with respect to the fins 302 described hereinabove, the end portion 306 is aligned with the intermediate portion 305, i.e. the assembly formed by the joining of the intermediate part 305 and the end part 306 is inclined with respect to the transverse direction T. The fins 302 of the longitudinal portion 301A at the bottom are inclined along the direction of flow of the reactive fluid, whereas the fins 302 attached to the longitudinal portion 301B at the top are inclined along the opposite direction of the flow of the reactive fluid.

In FIG. 16b), with respect to the fins 302 described hereinabove, the junction part 304 is aligned with the intermediate part 305, i.e. the assembly formed by the joining of the intermediate part 305 and the junction part 304 is inclined with respect to the transverse direction T. The fins 302 of the longitudinal portion 301A at the bottom are inclined along the direction of flow of the reactive fluid, whereas the fins 302 attached to the longitudinal portion 301B at the top are inclined along the opposite direction to the flow of the reactive fluid.

The aforementioned embodiments and variants can be combined with each other so as to generate new embodiments of the invention.

1-15. (canceled).

16. A stack of a fuel cell, the stack comprising:
a plurality of bipolar plates, which are identical to each other, which extend each along a median plane and which are stacked along a direction of stacking orthogonal to the median plane, two consecutive bipolar plates forming therebetween a cell of the stack, wherein:
each bipolar plate is formed by two monopolar plates, which are superimposed and which together form at least one pocket at one end of the bipolar plate, each pocket having an end opening configured to receive a pin of a module for measuring the fuel cell; and
any two successive bipolar plates are stacked head-to-tail.

17. The stack of a fuel cell according to claim 16, wherein:
each pocket opens out through the end opening along a direction of connection which is parallel to a longitudinal direction of the stack, the longitudinal direction being orthogonal to the direction of stacking; and
for any two consecutive bipolar plates, the direction of connection of each pocket of one of the two bipolar plates is oriented opposite to the direction of connection of each pocket of the other bipolar plate.

18. The stack of a fuel cell according to claim 16, wherein:
each bipolar plate comprises a connection area, wherein the at least one pocket of the bipolar plate is formed, and a mating area, which is located opposite the connection area with respect to a center of the bipolar plate;
for any two consecutive bipolar plates, the connection zone of one of the two bipolar plates is arranged opposite the mating zone of the other bipolar plate along the direction of stacking; and
the stack further comprises wedging means, which are interposed between each connection zone and the opposite mating zone, so as to limit the deformations of each pocket of the connection zone when the pin associated with the pocket is inserted into the pocket.

19. The stack of a fuel cell according to claim 18, wherein:
the mating zones comprise bulges which are provided protruding from the polar plates and which extend toward the facing connection zones, so as to limit the deformations of each pocket of the connection zone when the pin associated with the pocket is inserted into the pocket, forming the wedging means.

20. The stack of a fuel cell according to claim 18, wherein:
the wedging means comprise spacers which are interposed between each connection zone and the opposite mating zone; and
each spacer is fastened to the mating zone.

21. The stack of a fuel cell according to claim 20, wherein:
each bipolar plate comprises an outer anode face and an outer cathode face; and
for a given bipolar plate, the mating zone of the bipolar plate includes a spacer fastened to the anode face of the bipolar plate and a spacer fastened to the cathode face of the bipolar plate.

22. The stack of a fuel cell according to claim 20, wherein:
each bipolar plate comprises an outer anode face and an outer cathode face; and
for a given bipolar plate, the wedging means comprise three spacers, two of the spacers being arranged on either side of the mating zone of the bipolar plate, on the anode face of the bipolar plate and on the cathode face of the bipolar plate, respectively, whereas the third spacer is arranged between the two monopolar plates forming the bipolar plate.

23. The stack of a fuel cell according to claim 20, wherein:
the wedging means comprise spacers which are interposed between each connection zone and the opposite mating zone;
for each bipolar plate, the wedging means associated with the plate comprise bridges of material, which link the spacers together; and
the wedging means are mounted on an edge of the bipolar plate concerned, so that the spacers are located on each side of the mating zone.

24. The stack of a fuel cell according to claim 18, wherein:
the wedging means comprise spacers which are interposed between each connection zone and the opposite mating zone;
the stack further comprises membrane-electrode assemblies, each of which is received between two consecutive bipolar plates and which extend between the connection zones and the facing mating zones associated with the two bipolar plates; and
some of the spacers are fastened to the membrane-electrode assemblies.

25. The stack of a fuel cell according to claim 20, wherein the spacers are made of an elastomer material.

26. The stack of a fuel cell according to claim 16, wherein:
each bipolar plate comprises a connection area, wherein the at least one pocket of the bipolar plate is formed, and a mating area, which is located opposite the connection area with respect to a center of the bipolar plate;
for any two consecutive bipolar plates, the connection zone of one of the two bipolar plates is arranged opposite the mating zone of the other bipolar plate along the direction of stacking;
the connection zones are divided into two rows, the two rows extending along the direction of stacking; and
for each row, the end openings of the pockets of the row are geometrically supported by an opening plane, which is parallel to the axis of stacking, while the mating zones associated with the connection zones of the row are set back from the opening plane, at a distance from the opening plane comprised between 1 mm and 5 mm, preferably greater than or equal to 2 mm.

27. The stack of a fuel cell according to claim 16, wherein at least one cell of the stack comprises:
a first polar plate that includes:
a peripheral zone; and
a flow field of a reactive fluid, surrounded by the peripheral area;
a membrane-electrode assembly, which is superimposed on the first polar plate according to the direction of stacking, and which comprises:
a peripheral portion facing the peripheral zone along the direction of stacking;
a central portion comprising a proton exchange polymer membrane, surrounded by the peripheral portion; and
at least one gas diffusion layer which is interposed along the direction of stacking, between the proton exchange polymer membrane and the flow field of the first polar plate; and
a first peripheral seal comprising:
a main part interposed, along the direction of stacking, between the peripheral zone and the peripheral portion of the membrane-electrode assembly, the main part surrounding the flow field and the gas diffusion layer associated with the flow field, the main part providing a seal against a reactive fluid between, on the one hand, a compartment of the cell delimited inside the cell, between the peripheral portion of the membrane-electrode assembly and the peripheral zone and, on the other hand, a zone external to the cell beyond the main part facing the compartment; and
fins, which extend from the main portion into the compartment;
wherein:
the main part comprises two longitudinal portions, each of which extends parallel to a longitudinal direction orthogonal to the direction of stacking, which run along the flow field and are arranged on each side of the flow field, the compartment including two bypass zones, each of which is delimited between, on the one hand, a respective longitudinal portion and, on the other hand, the flow field and the gas diffusion layer associated with the flow field;
for each longitudinal portion, at least one fin extends from the longitudinal portion into the corresponding bypass zone, wherein each fin includes:
a junction part, via which the fin is attached to the corresponding longitudinal portion;
an end part interposed along the direction of stacking between the gas diffusion layer and the peripheral zone; and
an intermediate part, linking the junction part to the end part, the intermediate part being inclined, in projection onto the median plane, with respect to a transverse direction which is orthogonal to the direction of stacking and to the longitudinal direction;
for each longitudinal portion, the fin or fins attached to the longitudinal portion are inclined along the same direction with respect to the transverse direction; and
when the stack is in the operational configuration, the fins attached to the longitudinal portion located on the bottom are inclined in the same direction as a flow of a reactive fluid associated with the first polar plate.

28. The stack of a fuel cell according to claim 27, wherein
for each peripheral seal, the fins attached to opposite longitudinal portions are inclined along opposite directions with respect to the transverse direction.

29. A fuel cell comprising:
the stack according to claim 16;
two end plates on each side of the stack; and
a plurality of measurement modules, each configured to measure electrical characteristics of the cells, each module comprising pins, which are each connected to a respective pocket.

30. A vehicle comprising at least one fuel cell according to claim 29.
